(19) United States
(12) Patent Application Publication
(10) Pub. No.: US 2007/0226990 A1
(43) Pub. Date: Oct. 4, 2007

(54) Method for manufacturing lithium ion secondary cell

(75) Inventor: Shozo Morimoto, Niigata (JP)

Correspondence Address: SUGHRUE MION, PLLC, 2100 PENNSYLVANIA AVENUE, N.W., SUITE 800, WASHINGTON, DC, 20037, US

(73) Assignee: ARISAWA MFG. CO., LTD., Niigata (JP)

(21) Appl. No.: 11/730,169

(22) Filed: Mar. 29, 2007

(30) Foreign Application Priority Data
Mar. 31, 2006 (JP) 2006-097300

(51) Int. Cl. H01M 10/04

(52) U.S. Cl. 29/623.1

(57) ABSTRACT

The present invention provides a method for manufacturing a lithium ion secondary cell which has very good practical utility, is safe to use, is less expensive in comparison with conventional cells, and has high energy density. The present invention is a method for manufacturing a lithium ion secondary cell in which a positive electrode 1 and a negative electrode 2 are disposed via an interposed inorganic solid electrolyte 3, the method comprising forming into a three-dimensional shape the surface of an electrode selected from the positive electrode 1 and negative electrode 2 using a nanoimprint method; subsequently providing an inorganic solid electrolyte 3 on the electrode whose surface has been formed into a three-dimensional shape; and providing the other electrode on the inorganic solid electrolyte 3.

### BACKGROUND OF THE INVENTION

1. Field of the Invention

The present invention relates to a method for manufacturing a lithium ion secondary cell.

2. Description of the Related Art

Currently, non-aqueous electrolytic solvents and gel electrolytes in which the non-aqueous electrolytic solvents are held in a macromolecular polymer are used as the electrolytes of lithium ion secondary cells for mobile phones and notebook computers. Non-aqueous electrolytic solvents have lithium salt dissolved in propylene carbonate (PC), ethylene carbonate (EC), diethyl carbonate (DEC), ethyl methyl carbonate (EMC), dimethyl carbonate (DMC), or another organic solvent.

However, these non-aqueous electrolytic solvents are flammable and may possibly explode and ignite. In view of this possibility, the use of inorganic solid electrolytes as the electrolytes in a cell is being studied in order to solve this problem.

There is also a need to improve the energy density in order to extend operation time, and a specific example of a three-dimensional electrode is disclosed in Fardad Chamran, et al. “Proc. 208^{th} ECS Meeting, 3D Micro- and Nanoscale Cell Architectures,” 1226 (2005) (non-patent reference 1).

Specifically, conventional electrodes are flat, and therefore there is no other method than to use a plurality of cells in combination or to increase the surface area of the electrode in order to increase energy density. For this reason, the cells are unavoidably larger and are not suitable for mounting in small portable equipment or the like. By forming three-dimensional electrodes, however, the surface area of the electrodes can be dramatically increased and a cell having high energy density can be manufactured.

Non-patent Document 1: Fardad Chamran, et al. “Proc. 208^{th} ECS Meeting, 3D Micro- and Nanoscale Cell Architectures,” 1226 (2005).

Three-dimensional electrodes are very effective means for increasing the surface area of an electrode, but since lithography, MEMS (Micro Electro-Mechanical Systems), micro-thinning methods, and other semiconductor manufacturing techniques are used as the manufacturing method, the costs are high. There is furthermore a limit to forming three-dimensionally shaped electrodes at the micron level using the above-described manufacturing methods, and there is inevitably a limit to increasing the surface area.

### SUMMARY OF THE INVENTION

In view of the above-described current situation, an object of the present invention is to provide a method for manufacturing a lithium ion secondary cell which has very good practical utility and in which a three-dimensional shape can be formed on a nanosize level by using nanoimprint techniques, the manufacturing can be performed at a lower cost than the above-described conventional methods, the cells are safe to use because an inorganic solid electrolyte is employed, and the internal resistance of the cell can be reduced.

The main points of the present invention will be described with reference to the attached drawings.

There is provided a method for manufacturing a lithium ion secondary cell in which a positive electrode 1 and a negative electrode 2 are provided via an interposed inorganic solid electrolyte 3, the method comprising forming into a three-dimensional shape the surface of an electrode selected from the positive electrode 1 and negative electrode 2 using a nanoimprint method; subsequently providing an inorganic solid electrolyte 3 to the electrode whose surface has been formed into a three-dimensional shape; and providing the other electrode to the inorganic solid electrolyte 3.

In the method for manufacturing a lithium ion secondary cell according to the first aspect, the inorganic solid electrolyte 3 in the form of a thin film is layered on the electrode whose surface has been formed into a three-dimensional shape.

In the method for manufacturing a lithium ion secondary cell according to the first aspect, silicon is adopted as the active material comprising the electrode whose surface has been formed into a three-dimensional shape.

In the method for manufacturing a lithium ion secondary cell according to the second aspect, silicon is adopted as the active material comprising the electrode whose surface has been formed into a three-dimensional shape.

In the method for manufacturing a lithium ion secondary cell according to the third aspect, amorphous silicon or polysilicon is adopted as the silicon.

In the method for manufacturing a lithium ion secondary cell according to the fourth aspect, amorphous silicon or polysilicon is adopted as the silicon.

In the method for manufacturing a lithium ion secondary cell according to the any of the first to sixth aspects, the three-dimensional shape is a shape obtained by aligning several fine columnar bodies.

In the method for manufacturing a lithium ion secondary cell according to the seventh aspect, the height to diameter (or width) ratio of the fine columnar bodies is set to be 2:1 or higher.

In the method for manufacturing a lithium ion secondary cell according to the any of the first to sixth aspects, the inorganic solid electrolyte 3 is disposed on the electrode whose surface has been formed into a three-dimensional shape so that the three-dimensional shape is not lost, the other electrode is subsequently disposed on the inorganic solid electrolyte 3 so that the three-dimensional shape is not lost, and the remaining three-dimensional shape is subsequently filled with a filler 6.

In the method for manufacturing a lithium ion secondary cell according to the seventh aspect, the inorganic solid electrolyte 3 is disposed on the electrode whose surface has been formed into a three-dimensional shape so that the three-dimensional shape is not lost, the other electrode is subsequently disposed on the inorganic solid electrolyte 3 so that the three-dimensional shape is not lost, and the remaining three-dimensional shape is subsequently filled with a filler 6.

In the method for manufacturing a lithium ion secondary cell according to the eighth aspect, the inorganic solid electrolyte 3 is disposed on the electrode whose surface has been formed into a three-dimensional shape so that the three-dimensional shape is not lost, the other electrode is subsequently disposed on the inorganic solid electrolyte 3 so that the three-dimensional shape is not lost, and the remaining three-dimensional shape is subsequently filled with a filler 6.

In view of the foregoing, the present invention provides a lithium ion secondary cell which has very good practical utility and in which a very small three-dimensional shape can be formed on a nanosize level, electrodes having a large surface area can be formed at low cost, and the internal resistance of the cell can be reduced. Therefore, a lithium ion secondary cell that is safe to use can be obtained at low cost and high energy density in comparison with conventional cells.

### BRIEF DESCRIPTION OF THE DRAWINGS

FIG. 1 is a schematic explanatory diagram of a lithium ion secondary cell;

FIGS. 2(a) to 2(f) are schematic explanatory diagrams that describe the manufacturing steps of the present embodiment; and

FIGS. 3(a) to 3(d) are schematic explanatory diagrams that describe the manufacturing steps of the present embodiment.

### DESCRIPTION OF THE PREFERRED EMBODIMENTS

Advantageous embodiments of the present invention are briefly described with reference to the effects of the present invention on the basis of drawings.

A very small three-dimensional shape can be formed on a nanosize level, and electrodes (positive electrode 1 and negative electrode 2) having a large surface area can be formed at low cost by using the nanoimprint method, which makes microfabrication at low cost possible. Since an inorganic solid electrolyte 3 is used, there is naturally no possibility of explosion and ignition, a thin film can be formed, and the internal resistance of the cell can be reduced. Therefore, the present invention has very good practical utility and allows a lithium ion secondary cell that is safe to use and has high energy density to be obtained at low cost.

Specific embodiments of the present invention are described below with reference to the drawings.

The present embodiment, is a method for manufacturing a lithium ion secondary cell in which a positive electrode 1 and a negative electrode 2 are disposed via an interposed inorganic solid electrolyte 3, wherein the surface of the negative electrode 2 is formed into a three-dimensional shape using a nanoimprint method; a thin film inorganic solid electrolyte 3 is subsequently layered on the negative electrode 2 whose surface has been formed into a three-dimensional shape; a thin-film positive electrode 1 is then layered on the inorganic solid electrolyte 3, and a filler 6 is thereafter filled into the three-dimensional shape remaining on the surface of the positive electrode 1.

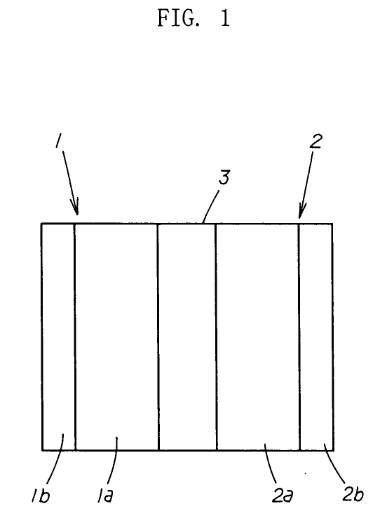

The lithium ion secondary cell has an electrolyte (inorganic solid electrolyte 3) held between a positive electrode 1 composed of a positive electrode active material 1a and a positive electrode collector 1b, and a negative electrode 2 composed a negative electrode active material 2a and a negative electrode collector 2b, as shown in FIG. 1. Lithium ions move between the positive electrode active material 1a and the negative electrode active material 2a by way of the electrolyte (inorganic solid electrolyte 3), whereby electric current is charged and discharged via the positive electrode collector 1b and negative electrode collector 2b.

Nanoimprinting is a method in which a mold (die) provided with a prescribed (nanosized) concavo-convex pattern (three-dimensional shape) is pressed against a solid or liquid resin or the like on a substrate to transfer the concavo-convex pattern.

Examples of three-dimensional shapes that are formed by nanoimprinting include cylindrical, polygonal pillars, and stripe (line) shapes that are aligned in the surface direction. In the present embodiment, a shape is adopted in which several cylindrical shapes are aligned in the surface direction, wherein the cylindrical shapes are, in particular, easy to form and have high mechanical strength and a large surface area. The aspect ratio (height to diameter ratio) of the cylindrical shapes is set to 2:1 or higher, and more preferably 5:1 or higher. The aspect ratio is preferably large as long as there is no problem in terms of mechanical strength and formation.

Examples of nanoimprinting primarily include thermal nanoimprinting and photo nanoimprinting. The former is a method that uses a solid thermoplastic resin as disclosed in “Stephan Y. Chou, et al., Applied Physics Letters, Vol. 67(21), 20 Nov. 1995, pp 3114-3116”, and U.S. Pat. No. 5,772,905, for example. The latter is a method that uses a liquid photocurable resin as disclosed in “M. Colburn, et al., Proc. of SPIE, 3676, 378 (1999),” for example.

Thermal nanoimprinting entails coating a thermoplastic resin on a substrate, heating the resin to the glass transition temperature of the resin or higher to soften the resin, then pressing a mold against the rein, reducing the temperature in this state to cure the resin, and peeling the mold away, whereby a pattern in which the three-dimensional shape and the concavo-convex shape of the mold are inverted is formed on the substrate. Examples of the mold material that can be used include Si, SiO₂/Si, SiC, and Ni. PMMA (polymethyl-methacrylate) or the like may be used as the thermoplastic resin.

Examples of the material that forms the negative electrode active material 2a on the substrate include metallic lithium, as well as LiAl, LiAg, LiPb, and LiSi alloys, which are alloys that contain lithium. It is also possible to use graphite, non-graphitizable carbon obtained by baking a resin to form a carbon, and graphitizable carbon obtained by heat treating coke, as well as fullerene and other common carbon materials.

Among the above, Si is particularly preferred as a substrate for microfabrication because various processing methods for semiconductor materials can be used, and is therefore preferred in the nanoimprinting method. Si is preferred as a negative electrode active material because the theoretical charge and discharge capacity is considerable, i.e., about 3,000 mAh/g when compared with graphite, which has a charge and discharge capacity of about 370 mAh/g.

On the other hand, materials that have a large theoretical capacity have very large coefficients of expansion and contraction that accompany charging and discharging. There is therefore a problem in that sufficient charge and discharge cycle characteristics cannot be obtained because the active material becomes pulverized and the collection characteristics deteriorate. Since this phenomenon occurs more readily when the active material has a crystal structure, a-Si (amorphous silicon) and p-Si (polysilicon) are preferably used as the silicon rather than a crystalline Si. A-Si is adopted in the present embodiment.

In the present embodiment, the thermal nanoimprinting method described above is used and a three-dimensional shape is specifically formed in the following manner.

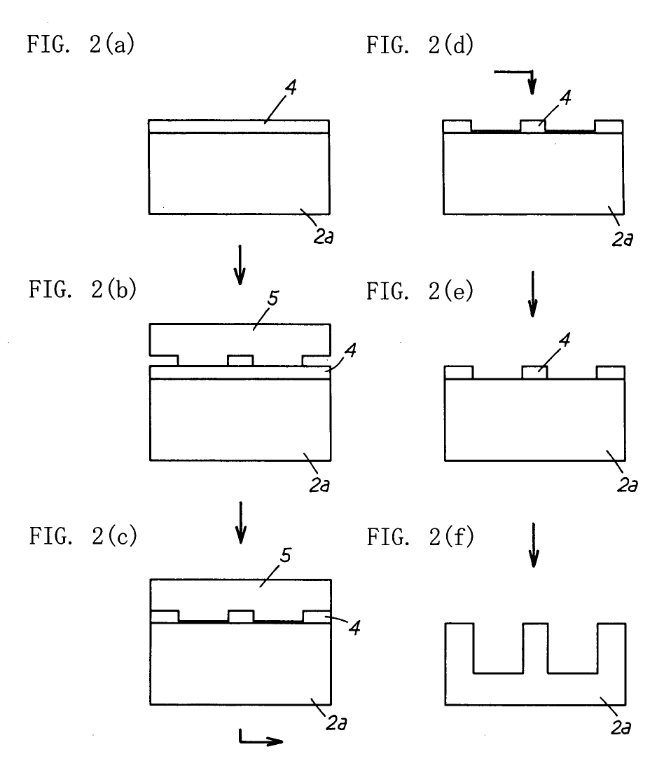

PMMA 4 is coated onto the surface of an a-Si substrate as the negative electrode active material 2a (FIG. 2(a)). The a-Si substrate is subsequently heated to the glass-transition temperature (105° C.) of the PMMA 4 or higher to soften the PMMA 4. An Si mold 5 provided with the three-dimensional shape (inverted shape of the three-dimensional shape of the negative electrode surface) is pressed against the PMMA 4 (FIG. 2(b)). With the mold in the pressed state, the PMMA 4 is cooled and allowed to cure and to transfer the three-dimensional shape of the Si mold 5 (FIG. 2(c)). The Si mold 5 is subsequently peeled away from the cured PMMA 4 (FIG. 2(d)), and the remaining film of the PMMA 4 that is left behind in the concave portions of the a-Si substrate is removed (FIG. 2(e)). After the surface of the a-Si substrate has been exposed, the surface of the a-Si substrate is dry etched using as a mask the PMMA 4 remaining in the convex portions of the a-Si substrate. The remaining film of the PMMA 4 on the a-Si substrate is then completely removed (FIG. 2(f)) to form (i.e., form concavities and convexities) the surface of the negative electrode 2 (the surface on the electrolyte side of the a-Si substrate) into a three-dimensional shape.

The photo nanoimprinting method entails coating a photocurable resin on a substrate, pressing a mold against the photocurable resin, irradiating UV rays at normal temperature to cure the photocurable resin while keeping the mold in a pressed state, and peeling the mold away from the photocurable resin to form a pattern. Quartz, which can transmit UV rays, may be used as the mold material, and an acrylic resin, epoxy resin, or the like may be used as the photocurable resin. In comparison with thermal nanoimprinting, photo nanoimprinting has high throughput because a resin can be cured by simply irradiating UV light. Also, positioning in relation to the substrate is made possible through the mold because a quartz mold is used.

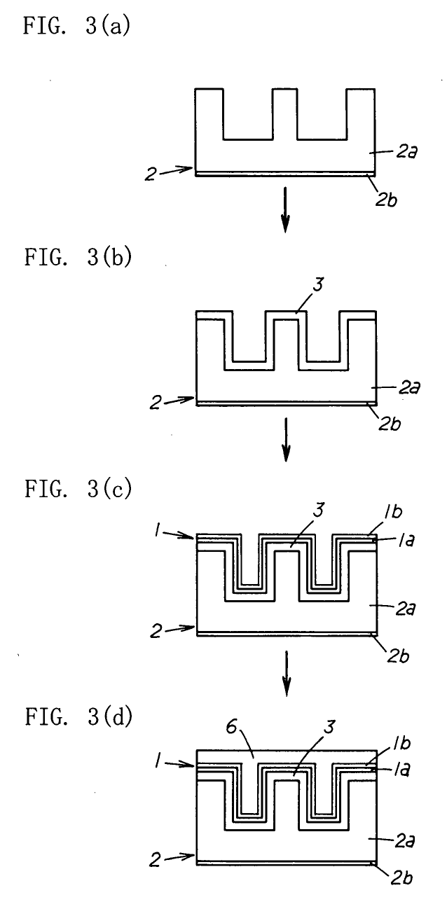

Next, a Cu thin film is disposed (FIG. 3(a)) as a negative electrode collector 2b on the reverse side of the negative electrode active material 2a (the side opposite of the surface on which the three-dimensional shape was formed as described above). A negative electrode 2 is composed of a Cu thin film as the negative electrode collector 2b, and an a-Si as the negative electrode active material 2a. In the present embodiment, the Cu thin film is provided after the surface of the negative electrode active material 2a has been formed into a three-dimensional shape, but the film may be provided at any time.

An inorganic solid electrolyte 3 is subsequently disposed on the surface of the negative electrode 2 (the surface of the negative electrode active material 2a). LiPON or another lithium phosphate, Li₂S—P₂S₅, thio-LISICON or another lithium sulfide, LiNbO₃ and LiTaO₃ or another composite oxide may be used as the inorganic solid electrolyte. Li₃PO₄ (lithium phosphate) is adopted in the present embodiment; i.e., thin film Li₃PO₄ is layered on the surface of the negative electrode 2 (FIG. 3(b)). Therefore, the three-dimensional shape still exists on the surface in a state in which the thin film Li₃PO₄ has been layered.

The inorganic solid electrolyte is ordinarily composed of microparticles having a diameter of about 10 μm, and may be used by being pressed onto the positive electrode active material or negative electrode active material, but the inorganic solid electrolyte is preferably used in the form of a thin film because the internal resistance of the cell can be reduced.

Next, the positive electrode active material 1a is disposed on the inorganic solid electrolyte 3. Any of the following may be used as the positive electrode active material: LiCoO₂ or another lithium/cobalt composite oxide, LiNiO₂ or another lithium/nickel composite oxide, LiMn₂O₄ or another lithium/manganese composite oxide, LiV₂O₅ or another lithium/vanadium composite oxide, or LiFeO₂ or another lithium/iron composite oxide. In the present embodiment, LiCoO₂ is adopted; i.e., a thin film LiCoO₂ is layered on the inorganic solid electrolyte 3. Therefore, the three-dimensional shape still exists on the surface in a state in which the thin film LiCoO₂ has been layered.

An Al thin film is subsequently formed as the positive electrode collector 1b on the surface of the positive electrode active material 1a (the side opposite from the surface which is in contact with the inorganic solid electrolyte 3). Therefore, the three-dimensional shape still exists on the surface in a state in which the thin film Al has been layered. The positive electrode 1 composed of an Al thin film as the positive electrode collector 1b and LiCoO₂ as the positive electrode active material 1a is formed on the inorganic solid electrolyte 3 (FIG. 3(c)).

Sputtering, CVD, vapor deposition, sol-gel, or another method may be used to form the inorganic solid electrolyte and the thin-film positive electrode active material or negative electrode active material. Sputtering and CVD are particularly preferred because a film is easily formed.

A filler 6 for filling the three-dimensional shape remaining on the surface of the positive electrode 1 is provided and the surface of the cell is smoothed (FIG. 3(d)). The electrode whose surface has been formed into a three-dimensional shape has poor mechanical strength in comparison with a flat (a two-dimensional shape) electrode, but a filler 6 is used to fill the three-dimensionally shaped gap (the concave portion of the concavo-convex pattern), and filling the gap improves the mechanical strength to substantially match that of a flat plate.

A low dielectric resin may be used, or an oxide film, a nitride film, or another film may be formed or deposited as the filler 6 as long as the columnar structure is not damaged by internal stress and a charge is not accumulated. An oxide film is adopted in the present embodiment.

With the present embodiment configured in the manner described above, a very small three-dimensional shape can be formed on a nanosize level, and electrodes (positive electrode 1 and negative electrode 2) having a large surface area can be inexpensively formed by using nanoimprint techniques that make low cost microfabrication possible. Since an inorganic solid electrolyte 3 is used, there is naturally no possibility of explosion and ignition, a thin film can be formed, and the internal resistance of the cell can be reduced.

Therefore, the present embodiment has very good practical utility and allows a lithium ion secondary cell that is safe to use and has high energy density to be obtained at low cost.

Experimental examples that underscore the effects of the present embodiment will be described.

### EXAMPLE 1

### Electrode Formation Step

A pattern in which columnar bodies having a diameter of 100 nm are aligned in a chessboard matrix at a pitch of 500 nm was drawn on an Si mold using an electron beam, and convexities were fabricated by dry etching.

An a-Si substrate was adopted as the negative electrode active material, and PMMA was coated onto the surface of the a-Si substrate. The a-Si substrate was subsequently heated to 140° C., which is greater than the glass-transition temperature (105° C.) of the PMMA, to soften the PMMA. An Si mold prepared in advance was pressed against the PMMA at a pressure of 10 MPa. With the mold in this pressed state, the PMMA was cooled and allowed to cure to transfer the pattern of the Si mold. The Si mold was subsequently peeled away from the cured PMMA, the remaining film of the PMMA left behind in the concave portions of the a-Si substrate were removed by reactive ion etching (RIE) with oxygen, and the surface of the a-Si substrate was exposed. The surface of the a-Si substrate was thereafter dry etched using as a mask the PMMA remaining in the convex portions of the a-Si substrate. The remaining film of the PMMA on the a-Si substrate was then completely removed to obtain a negative electrode active material having a three-dimensional surface shape in which columnar bodies having a diameter of 100 nm and a height of 500 nm were aligned in a chessboard matrix at a pitch of about 500 nm. A Cu film as the negative electrode collector was formed on the negative electrode active material to obtain a negative electrode. The Cu thin film may be formed prior to or following the electrode formation step, or may be performed prior to or following the filling step.

### Film Formation Step

An inorganic solid electrolyte and a positive electrode active material were formed on the negative electrode whose surface had been formed into a three-dimensional shape. In this situation, Li₃PO₄ was used as the inorganic solid electrolyte, and LiCoO₂ was used as the positive electrode active material. Al was formed as the positive electrode collector on the positive electrode active material.

The formation of the inorganic solid electrolyte, positive electrode active material, and positive electrode collector on the negative electrode was performed in the following manner.

The negative electrode was placed in a vacuum vessel, the surface of the three-dimensionally shaped negative electrode was placed on the side of the Li₃PO₄ inorganic solid electrolyte crystal, which was the vapor source (target), and the vapor was then exhausted. Argon gas was introduced when the pressure reached 1×10⁻⁴ Pa or less, and the pressure was kept at about 1×10⁻¹ Pa. The sintered body of the Li₃PO₄ inorganic solid electrolyte crystal, which was the vapor source, was placed on a copper plate having an internally disposed water cooled tube. A high frequency power source of 13.6 MHz was connected to the copper plate. The target surface was shielded using a shutter while the target surface was cleaned by pre-sputtering as the output from the power source was increased. The shutter was subsequently opened and the vaporized inorganic solid electrolyte was discharged from the target surface and deposited on the surface of the three-dimensional shaped negative electrode. When the film thickness reached 100 nm, the shutter was closed and power to the high frequency power source was stopped.

The same applies to the case in which LiCoO₂, which is used as a positive electrode active material, was formed as a film, but in this case, the gas that was introduced was a mixed gas composed of argon and oxygen. The Al film on the positive electrode collector was formed by sputtering using only argon gas. The thicknesses of the films were both 50 nm.

### Filling Step

After formation of the Al film as the positive electrode collector was completed, the target surface was shielded using a shutter, and argon gas was introduced. The pressure was set to 1×10⁻¹ to 1 PA, and an antenna was placed at a distance of 20 to 100 mm away from the Al film. The antenna was connected to a microwave power source of 2.4 GHz, power was provided, and the argon in the vacuum vessel was ionized to form a plasma state. Oxygen was subsequently mixed with the introduced argon gas to ultimately form a molar ratio of 1:1. TEOS (tetraethoxyorthosilicate) was then introduced to the vacuum vessel from another gas system, the TEOS was decomposed by the energy of the plasma, and a silica thin film was deposited on the Al surface to ultimately fill the gaps in the three-dimensional structure (the silica thin film was filled into the concavities of the three-dimensional shape, and the surface was smoothed).

A lithium ion secondary cell that used an inorganic solid electrolyte having mechanically strong three-dimensional structure was thereby obtained. In this structure, the surface area was 1.5 times greater than that of a conventional two-dimensional electrode per 10 mm×10 mm.

### EXAMPLE 2

### Electrode Formation Step

A pattern in which columnar bodies having a diameter of 100 nm were aligned in a chessboard matrix at a pitch of 50 nm was drawn on a surface of a quartz mold using an electron beam, and convexities were fabricated by dry etching.

An a-Si substrate was adopted as the negative electrode active material, and an acrylic resin (resist) was spin coated onto the surface of the a-Si substrate. A quartz mold prepared in advance was pressed against the resist at a pressure of about 0.08 MPa at room temperature, and UV rays (UV light) were irradiated through the quartz mold. The resist was cured for about 5 seconds, the quartz mold was peeled away, and the pattern of the quartz mold was then transferred onto the surface of the a-Si mold. The remaining film of the resist left behind in the concave portions of the a-Si substrate was removed by reactive ion etching with oxygen, and the surface of the substrate was exposed. The surface of the a-Si substrate was thereafter dry etched using as a mask the resist remaining in the convex portions of the a-Si substrate. The remaining film of the resist on the a-Si substrate was then completely removed to obtain a negative electrode active material having a three-dimensional surface shape in which columnar bodies having a diameter of 100 nm and a height of 500 nm were aligned in a chessboard matrix at a pitch of about 50 nm. A Cu film as the negative electrode collector was formed on the negative electrode active material to obtain a negative electrode. The Cu thin film may be formed prior to or following the electrode formation step, or may be performed prior to or following the filling step.

### Film Formation Step

An inorganic solid electrolyte and a positive electrode active material were formed on a negative electrode whose surface had been formed into a three-dimensional shape. In this situation, Li₃PO₄ was used as the inorganic solid electrolyte, and LiMn₂O₄ was used as the positive electrode active material. Al was formed as the positive electrode collector on the positive electrode active material.

The formation of the inorganic solid electrolyte, positive electrode active material, and positive electrode collector on the negative electrode was performed in the following manner.

The negative electrode was placed in a vacuum vessel, the surface of the three-dimensionally shaped negative electrode was placed on the side of the Li₃PO₄ inorganic solid electrolyte crystal, which was the vapor source (target), and the vapor was then exhausted. Argon gas was introduced when the pressure reached 1×10⁻⁴ Pa or less, and the pressure was kept at about 1×10⁻³ Pa. The Li₃PO₄ inorganic solid electrolyte crystal, which is the vapor source, was placed on a tungsten board or in a cylinder made of tungsten, and was heater using a heater. The space between the vapor source and the negative electrode was shielded using a shutter while the temperature was increased. When the vapor source reached a prescribed temperature, the shutter was opened and the vaporized inorganic solid electrolyte was discharged from the vapor source and deposited on the surface of the negative electrode. When the film thickness reached 5 nm, the shutter was closed and power to the heater was stopped. During this interval, the state in which the negative electrode can move with respect to the vapor source was maintained to assure uniform deposition velocity within the plane.

The same applies to the case in which LiMn₂O₄ used as the positive electrode active material was formed as a film, but in this case, the gas that was introduced when the pressure reached 1×10⁻⁴ Pa or less was argon gas alone. Gas was not introduced for the Al positive electrode collector, and the high vacuum state was maintained to form the film. The thicknesses of the films were both 5 nm.

### Filling Step

The filling step was carried out in the same manner as in the first example described above.

A lithium ion secondary cell that used an inorganic solid electrolyte having mechanically strong three-dimensional structure was thereby obtained. In this structure, the surface area was 7 times greater than a conventional two-dimensional electrode per 10 mm×10 mm.

The above confirms that the surface area can be increased in comparison with a conventional two-dimensional electrode by forming the negative electrode into a three-dimensional shape using nanoimprinting, and a lithium ion secondary cell can be obtained having an energy density that is greater by an amount commensurate to the increased surface area.

What is claimed is:

1. A method for manufacturing a lithium ion secondary cell in which a positive electrode and a negative electrode are disposed via an interposed inorganic solid electrolyte, the method comprising:
forming into a three-dimensional shape the surface of an electrode selected from the positive electrode and negative electrode using a nanoimprint method;
subsequently providing an inorganic solid electrolyte to the electrode whose surface has been formed into a three-dimensional shape; and
providing the other electrode to the inorganic solid electrolyte.

2. The method for manufacturing a lithium ion secondary cell according to claim 1, wherein the inorganic solid electrolyte in the form of a thin film is layered on the electrode whose surface has been formed into a three-dimensional shape.

3. The method for manufacturing a lithium ion secondary cell according to claim 1, wherein silicon is adopted as the active material comprising the electrode whose surface has been formed into a three-dimensional shape.

4. The method for manufacturing a lithium ion secondary cell according to claim 2, wherein silicon is adopted as the active material comprising the electrode whose surface has been formed into a three-dimensional shape.

5. The method for manufacturing a lithium ion secondary cell according to claim 3, wherein amorphous silicon or polysilicon is adopted as the silicon.

6. The method for manufacturing a lithium ion secondary cell according to claim 4, wherein amorphous silicon or polysilicon is adopted as the silicon.

7. The method for manufacturing a lithium ion secondary cell according to any of claims 1 to 6, wherein the three-dimensional shape is a shape obtained by aligning several fine columnar bodies.

8. The method for manufacturing a lithium ion secondary cell according to claim 7, wherein the height to diameter (or width) ratio of the fine columnar bodies is set to be 2:1 or higher.

9. The method for manufacturing a lithium ion secondary cell according to any of claims 1 to 6, comprising:
providing the inorganic solid electrolyte to the electrode whose surface has been formed into a three-dimensional shape so that the three-dimensional shape is not lost;
subsequently providing the other electrode so that the three-dimensional shape on the inorganic solid electrolyte is not lost; and
subsequently filling the remaining three-dimensional shape with a filler.

10. The method for manufacturing a lithium ion secondary cell according to claim 7, wherein
the inorganic solid electrolyte is disposed on the electrode whose surface has been formed into a three-dimensional shape so that the three-dimensional shape is not lost;
the other electrode is subsequently disposed so that the three-dimensional shape on the inorganic solid electrolyte is not lost; and
the remaining three-dimensional shape is subsequently filled with a filler.

11. The method for manufacturing a lithium ion secondary cell according to claim 8, wherein
the inorganic solid electrolyte is disposed on the electrode whose surface has been formed into a three-dimensional shape so that the three-dimensional shape is not lost;
the other electrode is subsequently disposed so that the three-dimensional shape on the inorganic solid electrolyte is not lost; and
the remaining three-dimensional shape is subsequently filled with a filler.
